(19) United States
(12) Patent Application Publication
(10) Pub. No.: US 2026/0065490 A1
(43) Pub. Date: Mar. 5, 2026

(54) IMAGE PROCESSING METHOD AND ELECTRONIC DEVICE

(71) Applicant: ASUSTeK COMPUTER INC., Taipei City (TW)

(72) Inventors: Yu Cho, Taipei City (TW); Jo-Fan Wu, Taipei City (TW)

(73) Assignee: ASUSTeK COMPUTER INC., Taipei City (TW)

(21) Appl. No.: 19/212,639

(22) Filed: May 19, 2025

(30) Foreign Application Priority Data
Aug. 29, 2024 (TW) 113132510

(51) Int. Cl. G06T 7/246; G06T 3/60; G06V 10/25; G06V 10/44

(52) U.S. Cl. CPC G06T 7/246; G06T 3/60; G06V 10/25; G06V 10/44

(57) ABSTRACT

An image processing method and an electronic device are provided. The method is adapted to the electronic device including an image capturing device. An initial region of interest (ROI) for enclosing a target object is determined, and an original video including multiple frames is captured through the image capturing device. Based on the initial ROI, an object tracking processing is performed on the frames to obtain an ROI in each frame. According to the ROI in each frame, an image stabilization processing is performed on each frame to obtain multiple corrected frames. Based on visible areas in the corrected frames, an optimal field of view is determined. A hyperlapse video is generated by extracting partial image blocks from each corrected frame according to the optimal field of view.

### CROSS-REFERENCE TO RELATED APPLICATION

This application claims the priority benefit of Taiwan application serial no. 113132510, filed on Aug. 29, 2024. The entirety of the above-mentioned patent application is hereby incorporated by reference herein and made a part of this specification.

### BACKGROUND

### Technical Field

The disclosure relates to an image processing method and an electronic device.

### Description of Related Art

Hyperlapse photography (also known as large-scale movement timelapse photography) is an emerging technology in timelapse photography. Hyperlapse photography involves changing the position of the camera with each exposure, shooting in a continuously moving manner. However, for general users, creating hyperlapse photography often presents many challenges. Compared with traditional timelapse photography, hyperlapse photography requires higher stability during the shooting process, otherwise the smoothness of the final hyperlapse video will be affected. General users often need equipment such as tripods to improve stability. In addition, users generally need to move to a large number of positioning points sequentially at a constant moving speed to capture images, in order to collect image materials corresponding to different shooting positions. In other words, users not only need to spend a lot of time to collect image materials to generate hyperlapse videos, but also spend a lot of time in post-production processing to generate hyperlapse videos. In summary, the creation of hyperlapse videos demands a higher level of technical proficiency from the photographer, meticulous attention to detail, and a considerable time investment to generate a hyperlapse video that meets expectations.

### SUMMARY

An image processing method for an electronic device including an image capturing device is provided in the disclosure. The method includes the following operation. The method includes the following operation. An initial region of interest (ROI) for enclosing a target object is determined, and an original video including multiple frames is captured through the image capturing device. Object tracking processing is performed on the frames based on the initial ROI to obtain an ROI in each frame. Image stabilization processing is performed on each frame to obtain multiple corrected frames according to the ROI in each frame. An optimal field of view (FOV) is determined according to visible areas in each corrected frame. A hyperlapse video is generated by extracting partial image blocks of each corrected frame according to the optimal field of view.

An electronic device, which includes an image capturing device and a processor, is included in the disclosure. The processor is coupled to the image capturing device. The processor is configured to perform the following operations. An initial region of interest (ROI) for enclosing a target object is determined, and an original video including multiple frames is captured through the image capturing device. Object tracking processing is performed on the frames based on the initial ROI to obtain an ROI in each frame. Image stabilization processing is performed on each frame to obtain multiple corrected frames according to the ROI in each frame. An optimal field of view is determined according to visible areas in each corrected frame. A hyperlapse video is generated by extracting partial image blocks of each corrected frame according to the optimal field of view.

Based on the above, in the embodiment of the disclosure, after the user selects the initial ROI, video recording, including multiple consecutive frames, may commence during the moving process. Through object tracking processing, the target object in each frame may be tracked to obtain the ROI in each frame. Through image stabilization processing, corrected frames of each of these frames may be obtained. Then, the optimal field of view may be determined according to the visible areas of these corrected frames, thereby generating a hyperlapse video by extracting partial image blocks of each frame according to the optimal field of view. Based on this, users may quickly generate hyperlapse videos through simple operations without having professional equipment and professional filming techniques.

### BRIEF DESCRIPTION OF THE DRAWINGS

FIG. 1 is a block diagram of an electronic device according to an embodiment of the disclosure.

FIG. 2 is a flowchart of an image processing method according to an embodiment of the disclosure.

FIG. 3 is a flowchart of image stabilization processing according to an embodiment of the disclosure.

FIG. 4 is a schematic diagram of target stabilization processing according to an embodiment of the disclosure.

FIG. 5 is a flowchart of determining the optimal field of view according to an embodiment of the disclosure.

FIG. 6 is a schematic diagram of determining the maximum field of view according to an embodiment of the disclosure.

FIG. 7 is a schematic diagram of timelapse processing according to an embodiment of the disclosure.

FIG. 8 is a schematic diagram of object tracking processing according to an embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts. These examples are only a portion of the disclosure and do not disclose all possible embodiments of the disclosure. More precisely, these embodiments are only examples of the device and method within the scope of the patent application of the disclosure.

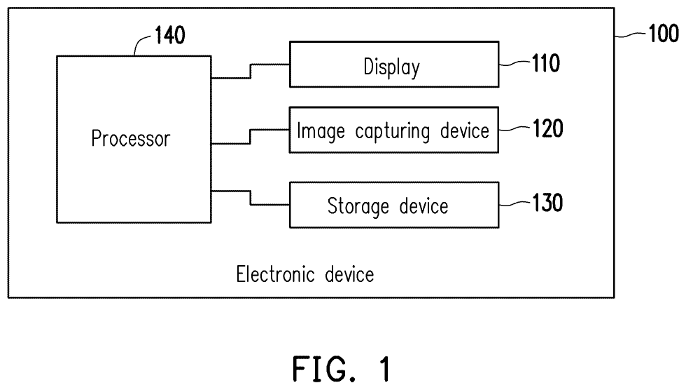

Referring to FIG. 1, the electronic device 100 may include a display 110, an image capturing device 120, a storage device 130, and a processor 140. The electronic device 100 may be, for example, various types of electronic equipment with image capturing capabilities, such as a smartphone, a digital camera, a tablet, a gaming console, an electronic wearable device or a photography device, and the type of the electronic device 100 is not limited thereto.

The display 110 may be various types of displays such as a liquid crystal display (LCD), a light-emitting diode (LED) display, an organic light-emitting diode (OLED) display, etc., which is not limited in the disclosure. The display 110 may be configured to display a program operation interface of a camera application, a preview screen or a composite image, etc.

The image capturing device 120 is configured to capture images, and may include lenses, image sensing elements, and other components. The lens may include an optical lens for controlling the light path. The image sensing element is configured to provide image sensing functions. The image sensing element may include a photosensitive element, such as a charge coupled device (CCD), a complementary metal-oxide semiconductor (CMOS) element or other elements, which is not limited in the disclosure. The lens may gather imaging light on the image sensing element to achieve the purpose of capturing images.

The storage device 130 is configured to store data such as files, images, commands, program codes, software modules, etc. The storage device may be, for example, any type of fixed or removable random access memory (RAM), read-only memory (ROM), flash memory, hard disk, or other similar devices, integrated circuits, or a combination thereof.

The processor 140 is coupled to the display 110, the image capturing device 120 and the storage device 130, and is, for example, a central processing unit (CPU), an application processor (AP), or other programmable general-purpose or special-purpose microprocessor, a digital signal processor (DSP), an image signal processor (ISP), a graphics processing unit (GPU) or other similar devices, integrated circuits, or combinations thereof. In some embodiments, the processor 140 may execute commands or program codes in the storage device 130 to implement each step of the image processing method in the embodiment of the disclosure.

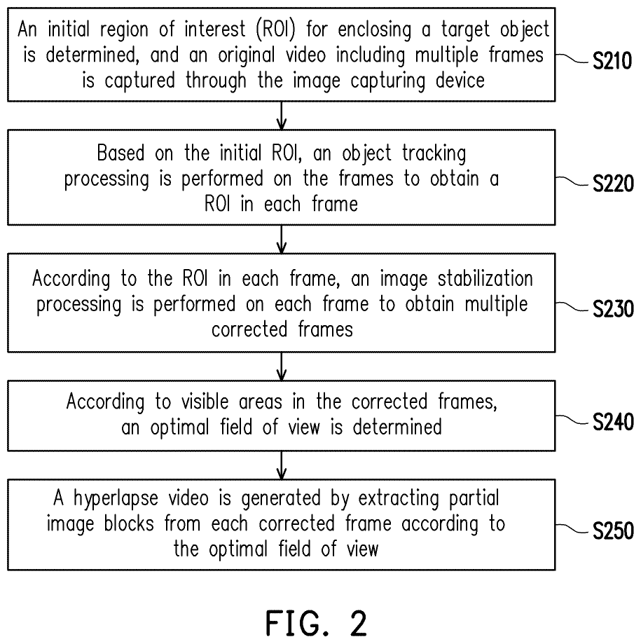

FIG. 2 is a flowchart of an image processing method according to an embodiment of the disclosure. Referring to FIG. 2, the method of this embodiment may be executed by the electronic device 100 in FIG. 1, and the details of each step in FIG. 2 will be described below with reference to the elements shown in FIG. 1.

In step S210, the processor 140 determines an initial ROI for enclosing the target object, and captures an original video including multiple frames through the image capturing device 120. In some embodiments, the processor 140 may receive user operations from the user to set the initial ROI. For example, the display 110 may display a user operation interface of a camera application including a preview screen, and the user may set an initial ROI by executing enclosing operation on the target object in the preview screen. After completing the setting of the initial ROI, the processor 140 may provide movement prompts through the user operation interface of the camera application, so that the user may refer to the movement prompts of the user operation interface of the camera application and move along the prompt route. For example, the user may hold the electronic device 100 and move toward the shooting target, and the electronic device 100 records the original video during the moving process.

Therefore, while the electronic device 100 is moving, the processor 140 captures an original video including multiple frames through the image capturing device 120. In some embodiments, the image capturing device 120 may record the original video according to a capture frame rate (units in fps), and the original video may include N consecutive frames Frame₁, Frame₂, Frame₃, . . . , Frame_{N}.

In step S220, the processor 140 performs object tracking processing on multiple frames based on the initial ROI to obtain the ROI in each frame. Furthermore, the processor 140 may use one or more object tracking algorithms to track the target object appearing in each frame to identify the position of the target object in each frame. The position of the target object in each frame may be subsequently configured to perform image stabilization processing on each frame to roughly calibrate the target object to a fixed image position in the hyperlapse video.

In some embodiments, the processor 140 may obtain the ROI of each frame by executing object tracking based on image feature points. A target frame of each frame may also be referred to as the region of interest (ROI) including the target object. It should be noted that in some embodiments, the ROI of the first frame Frame₁ of the original video is the initial ROI set by the user. Based on the optical flow tracking algorithm or other feature matching algorithms, the processor 140 may detect the ROIs of each frame sequentially.

In step S230, the processor 140 performs image stabilization processing on multiple frames to obtain multiple corrected frames. Furthermore, the processor 140 may generate a corrected frame of each frame by performing geometric transformation processing on each frame. The above-mentioned geometric transformation processing may include translation compensation, rotation compensation, or a combination thereof. The processor 140 may calibrate the target object at the same position in each corrected frame by performing geometric transformation processing on each frame. From another point of view, the frame center points of the ROIs in each corrected frame are located at the same image coordinates.

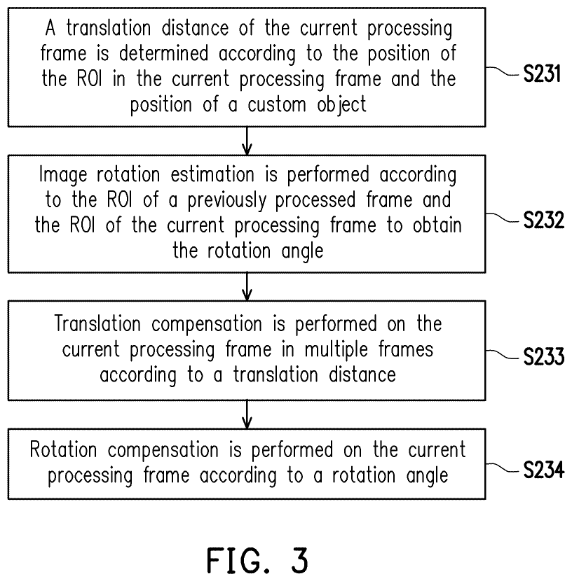

Referring to FIG. 3, FIG. 3 is a flowchart of image stabilization processing according to an embodiment of the disclosure. In some embodiments, step S230 may be implemented as steps S231 to S234.

In step S231, the processor 140 determines the translation distance of the current processing frame according to the position of the ROI in the current processing frame and the custom object position. In some embodiments, the translation distance includes a horizontal movement distance and a vertical movement distance. In some embodiments, the current processing frame may be the i^{th} frame among N frames, where i is less than or equal to N and greater than or equal to 1. The processor 140 may calculate the translation distance (dₓ, d_{y}) between the frame center point of the ROI and the custom object position in the i^{th} frame, which includes the horizontal movement distance dₓ on the X-axis and the vertical movement distance d_{y} on the Y-axis. In different embodiments, the custom object position may be the frame center point of the initial ROI, the image center point, or other custom positions.

In step S232, the processor 140 performs image rotation estimation according to the ROI of a previously processed frame and the ROI of the current processing frame to obtain the rotation angle. In some embodiments, the current processing frame may be the j^{th} frame among N frames, and the previously processed frame may be the (j−1)^{th} frame among N frames, where j is less than or equal to N and greater than 1. The processor 140 may calculate the image feature change between the ROI of the j^{th} frame and the ROI of the (j−1)^{th} frame, thereby estimating the rotation angle θⱼ of the j^{th} frame compared to the (j−1)^{th} frame. It should be noted that rotation compensation is not necessary for the initial frame (i.e., the first frame).

In step S233, the processor 140 performs translation compensation on the current processing frame among multiple frames according to a translation distance. In other words, the processor 140 may perform image translation in geometric transformation on the i^{th} frame according to the translation distance (dₓ, d_{y}) of the i^{th} frame. That is, the processor 140 may translate the current processing frame along the X-axis according to the horizontal movement distance dₓ of the current processing frame, and translate the current processing frame along the Y-axis according to the vertical movement distance d_{y} of the current processing frame.

In step S234, the processor 140 performs rotation compensation on the current processing frame according to a rotation angle. In other words, the processor 140 may perform image rotation in geometric transformation on the j^{th} frame according to the rotation angle θⱼ of the j^{th} frame. The processor 140 may rotate each pixel in the current processing frame around a certain reference point (usually a center point) to update the pixel position of each pixel according to the specified rotation angle. For example, the processor 140 may multiply the pixel position of each pixel in the current processing frame by a rotation matrix to obtain the updated pixel position.

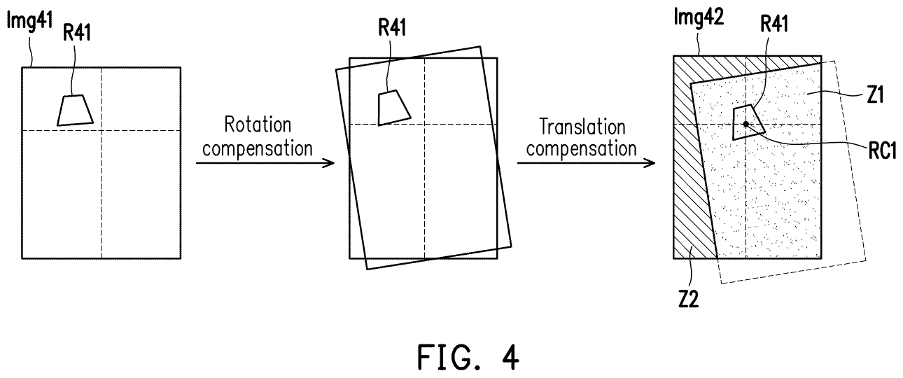

For example, referring to FIG. 4, FIG. 4 is a schematic diagram of target stabilization processing according to an embodiment of the disclosure. The processor 140 may perform rotation compensation on a certain frame Img41, and then perform translation compensation on the frame Img41. Thus, the processor 140 may obtain the corrected frame Img42 of the frame Img41. It should be noted that, after rotation compensation and translation compensation, the corrected frame Img42 may include a visible area Z1 (dotted area shown in the figure) and a non-visible area Z2 (hatched area shown in the figure). The non-visible area Z2 may generally be set as a monochrome area without shooting scene content. After rotation compensation and translation compensation, the frame center point RC1 of the ROI (R41) in the corrected frame Img42 will be located at the custom object position (e.g., the frame center point of the initial ROI).

It may be seen that the center point of the ROI in each corrected frame is located at the same custom object position. In addition, after geometric transformation, each corrected frame includes a visible area with the shooting scene content and a non-visible area that does not include the shooting scene content.

Returning to FIG. 2, in step S240, the processor 140 determines an optimal field of view (FOV) according to the visible areas in each corrected frame. Furthermore, as mentioned above, each corrected frame includes a non-visible area. Therefore, the processor 140 determines the optimal field of view for cropping all corrected frames to prevent the non-visible area of any corrected frame from appearing in the final hyperlapse video.

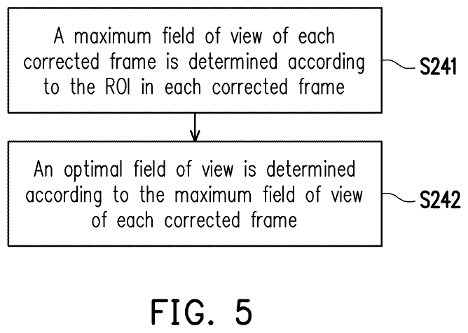

Referring to FIG. 5, FIG. 5 is a flowchart of determining the optimal field of view according to an embodiment of the disclosure. In some embodiments, step S240 may be implemented as steps S241 to S242.

In step S241, the processor 140 determines the maximum field of view of each corrected frame according to the ROI in each corrected frame. In some embodiments, the current processing frame may be the i^{th} frame among N frames, where i is less than or equal to N and greater than or equal to 1. In some embodiments, the processor 140 may determine the maximum field of view in the i^{th} corrected frame according to the visible range boundary of the visible area in the i^{th} corrected frame, the frame center point of the ROI in the i^{th} corrected frame, and an aspect ratio. A field end point of the maximum field of view in the i^{th} corrected frame is located on the visible range boundary in the i^{th} corrected frame. The above aspect ratio is the ratio between the width and height of the maximum field of view in the i^{th} corrected frame. The processor 140 determines the maximum field of view of each corrected frame according to the same aspect ratio. In other words, the aspect ratio of the maximum field of view of each corrected frame is the same.

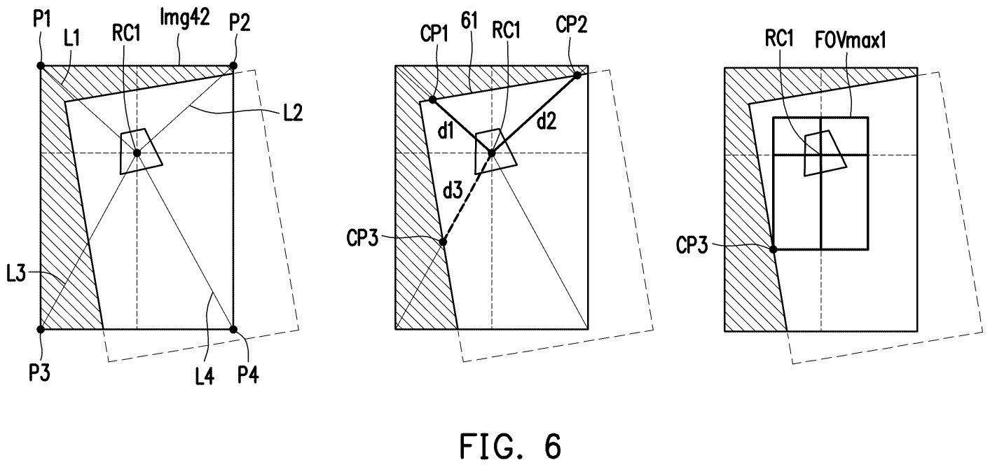

Referring to FIG. 6, FIG. 6 is a schematic diagram of determining the maximum field of view according to an embodiment of the disclosure. The processor 140 connects the frame center point RC1 of the ROI of the corrected frame Img42 and the four image corner points P1 to P4 of the corrected frame Img42 respectively, and generates four connecting lines L1 to L4 respectively.

Next, the processor 140 identifies the intersection points CP1 to CP3 between the four connecting lines L1 to L4 and the visible range boundary 61 of the visible area in the corrected frame Img42. The processor 140 may obtain the maximum field of view FOVmax1 based on the distances d1, d2, and d3 between the frame center point RC1 and the intersection points CP1 to CP3. Specifically, the processor 140 may determine that the ratio between d3 and L3 is the smallest by comparing the ratio between d1 and L1, the ratio between d2 and L2, and the ratio between d3 and L3. Therefore, the processor 140 may determine to use the ratio between d3 and L3 as the scaling ratio of the corrected frame Img42. After the scaling ratio is determined, the corrected frame Img42 is proportionally scaled with the frame center point RC1 as the center to become the maximum field of view FOVmax1. It may be seen from this that, the maximum field of view of each corrected frame is variable based on the varying magnitudes of geometric transformations applied to each corrected frame.

Then, in step S242, the processor 140 determines the optimal field of view according to the maximum field of view of each corrected frame. In some embodiments, the processor 140 may compare the field of view sizes of multiple maximum fields of view of multiple corrected frames to determine the optimal field of view. The optimal field of view is the smallest of multiple maximum fields of view to ensure that non-visible areas without scene content are not captured according to the optimal field of view when generating hyperlapse videos.

Returning to FIG. 2, in step S250, the processor 140 generatse a hyperlapse video by extracting partial image blocks from each corrected frame according to the optimal field of view. That is, the optimal field of view is applied to perform cropping processing on each corrected frame to obtain a partial image block excluding the non-visible area of each corrected frame. Afterwards, the processor 140 may perform timelapse processing on the partial image blocks of each corrected frame to obtain a hyperlapse video.

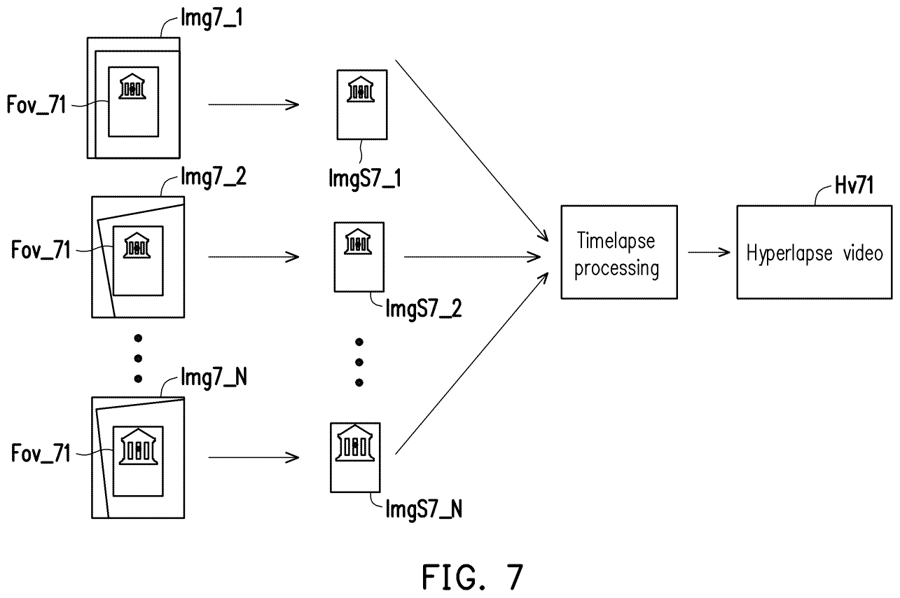

For example, referring to FIG. 7, FIG. 7 is a schematic diagram of timelapse processing according to an embodiment of the disclosure. The processor 140 uses the optimal field of view Fov_71 to extract partial image blocks ImgS7_1 to ImgS7_N of each corrected frame Img7_1 to Img7_N. Afterwards, the processor 140 may perform timelapse processing on some of the image blocks ImgS7_1 to ImgS7_N to obtain the hyperlapse video Hv71. Assuming that the target object is a building, a reference point of the building will be roughly fixed at the same position in the partial image blocks ImgS7_1 to ImgS7_N. Timelapse processing may be performed by adopting various algorithms commonly used in the art to generate timelapse videos, and the disclosure is not limited thereto.

In some embodiments, the processor 140 may perform feature point detection on an initial frame of the video based on the initial ROI to obtain multiple initial feature points for the optical flow tracking algorithm. The processor 140 may execute feature point detection based on a scale invariant feature transformation (SIFT) algorithm or a speeded up robust features (SURF) algorithm or other algorithms, and the disclosure is not limited thereto. Then, the processor 140 may use the optical flow tracking algorithm to perform object tracking processing on multiple frames, thereby obtaining the ROI and multiple optical flow feature points of each frame. Furthermore, the processor 140 may use the initial feature points as the tracking basis of the optical flow tracking algorithm, and perform object tracking processing on multiple frames to obtain the ROI and multiple optical flow feature points in each frame.

In some embodiments, the processor 140 may use optical flow tracking algorithm to track the feature points in the j^{th} frame, and determine the ROI in the j^{th} frame according to the feature points in the j^{th} frame. Where j is an integer greater than 1 and less than or equal to N, and N is the amount of frames in the original video.

It is worth mentioning that in some embodiments, the processor 140 may perform feature point detection on the j^{th} frame among multiple frames to obtain multiple current feature points of the j^{th} frame. The processor 140 may determine multiple filtered feature points based on matching results between multiple current feature points of the j^{th} frame and multiple optical flow feature points of the j^{th} frame. After that, the processor 140 may use the optical flow tracking algorithm to perform object tracking processing on the (j+1)^{th} frame according to the multiple filtered feature points of the j^{th} frame, thereby obtaining the ROI and multiple optical flow feature points in the (j+1)^{th} frame. Based on this, the reliability of the feature points in each frame may be improved, and the accuracy of object tracking may be improved.

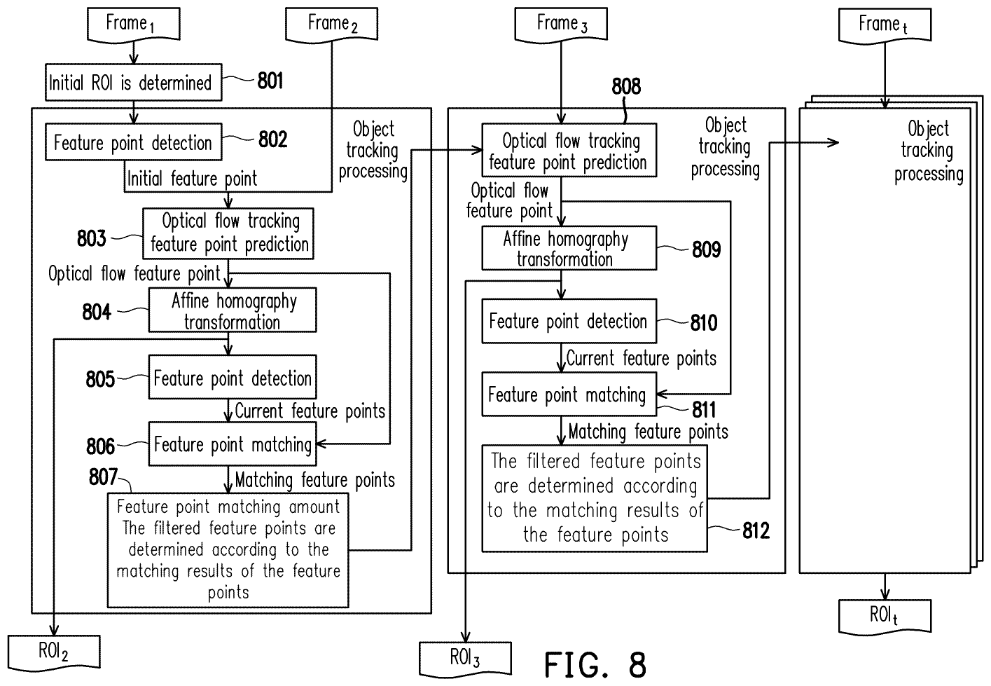

Referring to FIG. 8, FIG. 8 is a schematic diagram of object tracking processing according to an embodiment of the disclosure. In operation 801, the processor 140 may determine an initial ROI according to user operations. In operation 802, when the processor 140 performs the object tracking process, the processor 140 may first perform feature point detection on the initial ROI in the initial frame Frame₁ to determine the initial feature points in the initial ROI. In operation 803, the processor 140 performs optical flow tracking on the second frame Frame₂ according to the initial feature points to predict multiple optical flow feature points in the second frame Frame₂. In operation 804, the processor 140 performs affine homography transformation on the ROI determined according to multiple optical flow feature points to obtain the ROI (ROI₂) of the second frame Frame₂.

In operation 805, the processor 140 performs feature point detection on the ROI (ROI₂) of the second frame Frame₂, and obtains multiple current feature points of the second frame Frame₂. The processor 140 may execute feature point detection based on a scale invariant feature transformation (SIFT) algorithm or a speeded up robust features (SURF) algorithm or other algorithms, and the disclosure is not limited thereto.

In operation 806, the processor 140 performs feature point matching on multiple current feature points and multiple optical flow feature points of the second frame Frame₂. The processor 140 may perform feature point matching based on a cross-matching algorithm, a KNN matching algorithm, a RANSAC algorithm or other algorithms, and the disclosure is not limited thereto. Afterwards, in operation 807, the processor 140 may determine multiple filtered feature points according to the matching results between multiple current feature points of the second frame Frame₂ and multiple optical flow feature points of the second frame Frame₂.

In some embodiments, the processor 140 may determine whether the amount of matching feature points is greater than a threshold value. If the amount of matching feature points is greater than the threshold value, the processor 140 may determine that the filtered feature points of the second frame Frame₂ are these matching feature points. Otherwise, if the amount of matching feature points is not greater than the threshold value, the processor 140 may determine that the filtered feature points of the second frame Frame₂ are multiple current feature points of the second frame Frame₂.

Afterwards, in operation 807, the processor 140 may use the optical flow tracking algorithm to perform object tracking processing on the third frame Frame₃ according to the multiple filtered feature points of the second frame Frame₂, thereby obtaining multiple optical flow feature points of the third frame Frame₃ and the corresponding ROI (ROI₃). It should be noted that the implementation of operations 809 to 812 is similar to the implementation of operations 804 to 807, and is not repeated herein. That is, the processor 140 may repeatedly execute the above operations to obtain other ROIs (ROIₜ) of other frames Frameₜ.

To sum up, in the embodiment of the disclosure, after the user selects the initial ROI, video recording, including multiple consecutive frames, may commence during the moving process. Through object tracking processing, the target object in each frame may be tracked to obtain the ROI in each frame. Through image stabilization processing, corrected frames of each of these frames may be obtained. Then, the optimal field of view may be determined according to the visible areas of these corrected frames, thereby generating a hyperlapse video by extracting partial image blocks of each frame according to the optimal field of view. Based on this, users may quickly generate hyperlapse videos through simple operations without having professional equipment and professional filming techniques. In addition, the time-consuming process of generating a hyperlapse video may be greatly reduced, and a hyperlapse video with high image smoothness may be generated.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and their equivalents and not by the above detailed descriptions.

What is claimed is:

1. An image processing method for an electronic device comprising an image capturing device, the method comprising:
determining an initial region of interest (ROI) for enclosing a target object, and capturing an original video comprising a plurality of frames through the image capturing device;
performing object tracking processing on the frames based on the initial ROI to obtain an ROI in each of the frames;
performing image stabilization processing on each of the frames to obtain a plurality of corrected frames according to the ROI in each of the frames;
determining an optimal field of view (FOV) according to a visible area in each of the corrected frames; and
generating a hyperlapse video by extracting partial image blocks of each of the corrected frame according to the optimal field of view.

2. The image processing method according to claim 1, wherein performing the image stabilization processing on each of the frames to obtain the corrected frames according to the ROI in each of the frames comprises:
performing translation compensation on a current processing frame among the frames according to a translation distance; and
performing rotation compensation on the current processing frame according to a rotation angle.

3. The image processing method according to claim 2, wherein performing the image stabilization processing on each of the frames to obtain the corrected frames according to the ROI in each of the frames further comprises:
determining the translation distance of the current processing frame according to a position of the ROI in the current processing frame and a custom object position, wherein the translation distance comprises a horizontal movement distance and a vertical movement distance.

4. The image processing method according to claim 2, wherein performing the image stabilization processing on each of the frames to obtain the corrected frames according to the ROI in each of the frames further comprises:
performing image rotation estimation according to the ROI of a previously processed frame and the ROI of the current processing frame to obtain the rotation angle.

5. The image processing method according to claim 1, wherein a center point of the ROI in each of the corrected framed are located at a custom object position.

6. The image processing method according to claim 1, wherein determining the optimal field of view according to the visible area in each of the corrected frames comprises:
determining a maximum field of view of each of the corrected frames according to the ROI in each of the corrected frames; and
determining the optimal field of view according to the maximum field of view of each of the corrected frames.

7. The image processing method according to claim 6, wherein determining the maximum field of view of each of the corrected frames according to the ROI in each of the corrected frames comprises:
determining the maximum field of view in an i^{th} corrected frame according to a visible range boundary of the visible area in the i^{th} corrected frame, a frame center point of the ROI in the i ^{th} corrected frame, and an aspect ratio.

8. The image processing method according to claim 7, wherein a field end point of the maximum field of view in the i^{th} corrected frame is located on the visible range boundary in the i^{th} corrected frame.

9. The image processing method according to claim 6, wherein determining the optimal field of view according to the maximum field of view of each of the corrected frames comprises:
comparing field of view sizes of a plurality of maximum fields of view of the corrected frames to determine the optimal field of view, wherein the optimal field of view is the smallest of the maximum fields of view.

10. The image processing method according to claim 1, wherein performing the object tracking processing on the frames based on the initial ROI to obtain the ROI in each of the frames comprises:
performing feature point detection on an initial frame of the original video based on the initial ROI to obtain a plurality of initial feature points for an optical flow tracking algorithm; and
performing the object tracking processing on the frames by using the optical flow tracking algorithm, thereby obtaining the ROI and a plurality of optical flow feature points of each of the frames.

11. The image processing method according to claim 10, wherein performing the object tracking processing on the frames by using the optical flow tracking algorithm, thereby obtaining the ROI and the optical flow feature points of each of the frames comprises:
performing the feature point detection on a j^{th} frame among the frames to obtain a plurality of current feature points of the j^{th} frame, wherein j is an integer greater than 1 and less than or equal to N, and N is an amount of the frames;
determining a plurality of filtered feature points according to matching results between the current feature points of the j^{th} frame and the optical flow feature points of the j^{th} frame; and
performing the object tracking processing on a (j+1)^{th} frame by using the optical flow tracking algorithm according to the filtered feature points of the j^{th} frame, thereby obtaining the ROI and the optical flow feature points in the (j+1)^{th} frame.

12. An electronic device, comprising:
an image capturing device; and
a processor, coupled to the image capturing device, and configured to:
determine an initial region of interest (ROI) for enclosing a target object, and capture an original video comprising a plurality of frames through the image capturing device;
perform object tracking processing on the frames based on the initial ROI to obtain an ROI in each of the frames;
perform image stabilization processing on each of the frames to obtain a plurality of corrected frames according to the ROI in each of the frames;
determine an optimal field of view according to visible areas in each of the corrected frames; and
generate a hyperlapse video by extracting partial image blocks of each of the corrected frame according to the optimal field of view.
